(19) United States
(12) Patent Application Publication
(10) Pub. No.: US 2024/0360390 A1
(43) Pub. Date: Oct. 31, 2024

(54) VAPOR PHASE SOLVENT PLATING MASK REMOVER

(71) Applicant: Illinois Tool Works Inc., Glenview, IL (US)

(72) Inventor: Paul Blair, Jonesboro, GA (US)

(21) Appl. No.: 18/643,617

(22) Filed: Apr. 23, 2024

Related U.S. Application Data
(60) Provisional application No. 63/461,728, filed on Apr. 25, 2023.

(51) Int. Cl. C11D 7/50; B08B 3/08; B08B 3/10; B08B 5/00; C11D 7/26; C11D 7/30

(52) U.S. Cl. CPC C11D 7/5018; B08B 3/08; B08B 3/106; B08B 5/00; C11D 7/266; C11D 7/30; B08B 2203/007

(57) ABSTRACT

Manufacturers, particularly manufacturers of parts for aerospace applications, may use a plating mask to mask parts when plating. Plating masks may be used to mask a metallic part during etching and plating. After etching and plating, the plating mask needs to be removed. The present disclosure describes a solvent blend for removing a plating mask that comprises a co-solvent and a vapor phase cleaning solvent, wherein the co-solvent has a higher boiling point than the vapor phase cleaning solvent. In some embodiments, the co-solvent comprises isopropyl myristate. In some embodiments, the vapor phase cleaning solvent comprises a mixture of trans-1,2-dichloroethylene and hydrofluoroether.

### CROSS-REFERENCE TO RELATED APPLICATIONS

This application claims benefit of priority to U.S. provisional patent application No. 63/461,728, entitled “Vapor phase solvent plating mask remover”, filed Apr. 25, 2023, the contents of which are herein incorporated by reference in their entirety.

### BACKGROUND

Plating metallic layers onto parts is a commonly used technique in a variety of industries, including the aerospace industry. A microcrystalline wax that tolerates harsh, high temperature plating baths is commonly used to mask parts prior to plating. Perchloroethylene (“PERC”) is a solvent that is commonly used to remove a masking wax through a vapor phase cleaning process.

The wax may be removed in various steps, including first immersing the masked part in boiling water (which melts the bulk of the wax, which subsequently floats to the surface of the water). This is an incomplete process and subsequent processes are required. The last step in the process is vapor phase cleaning in PERC.

The masked part may also be re-immersed in a molten wax bath (210 to 230 degrees F.). If the part is left in the molten wax long enough, the part reaches the same temperature of the molten wax and the bulk of the wax melts off. Again here the last step is vapor phase cleaning in PERC.

While PERC has desirable properties for wax removal (i.e., it is non-flammable and has a high boiling point), there exists a desire to develop alternative solvents for removing a masking wax.

### SUMMARY

In an aspect, the disclosure provides a solvent blend for removing a plating mask that comprises a co-solvent and a vapor phase cleaning solvent, wherein the co-solvent has a higher boiling point than the vapor phase cleaning solvent. In some embodiments, the co-solvent comprises isopropyl myristate. In some embodiments, the vapor phase cleaning solvent comprises a mixture of trans-1,2-dichloroethylene and hydrofluoroether. In some embodiments, the vapor phase cleaning solvent comprises trans-1,2-dichloroethylene and hydrofluoroether are combined at a ratio of 10:1. In some embodiments, the co-solvent and the vapor phase cleaning solvent are combined at a ratio of 4:1.

In another aspect, the disclosure provides a method for removing a plating mask. In embodiments, the method comprises heating a solvent blend that comprises a co-solvent and a vapor phase cleaning solvent to an elevated temperature to produce a heated solvent blend, wherein the co-solvent has a higher boiling point than the vapor phase cleaning solvent; dipping a metal substrate that has had a plating mask applied to it into the heated solvent blend; maintaining the metal substrate in the heated solvent for a first cleaning period; removing the metal substrate from the heated solvent blend and into a cooling zone for a cooling period, wherein the cooling zone is located at a position above any vapor formed from the heated solvent blend; placing the metal substrate in a position close enough to the heated solvent such that the metal substrate is in contact with the vapor produced from the vapor phase cleaning solvent for a second cleaning period; and moving the metal substrate to the cooling zone for a second cooling period. In some embodiments, the co-solvent comprises isopropyl myristate. In some embodiments, the vapor phase cleaning solvent comprises a mixture of trans-1,2-dichloroethylene and hydrofluoroether. In some embodiments, the vapor phase cleaning solvent comprises trans-1,2-dichloroethylene and hydrofluoroether at a mixed at a ratio of 10:1. In some embodiments, the co-solvent and the vapor phase cleaning solvent are combined at a ratio of 4:1. In some embodiments, the elevated temperature is lower than the melting point of the plating mask. In some embodiments, the plating mask comprises microcrystalline wax. In some embodiments, the metal substrate is subjected to a de-waxing tank prior to dipping the metal substrate into the heated solvent blend. In some embodiments, the de-waxing tank comprises boiling water. In other embodiments, the de-waxing tank comprises molten wax.

### BRIEF DESCRIPTION OF DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

The FIGURE illustrates a process for etching a metal substrate in accordance with aspects of the disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The disclosure provides a formulation for removing masking material used in connection with a process for etching a metal substrate. For example, a process for etching a metal substrate may comprise applying a masking material, de-smutting the metal substrate in a caustic solution, rinsing the metal substrate to remove the caustic solution from the surface of the metal substrate, acid etching the metal substrate in an acidic etching solution, optionally rinsing the metal substrate to remove the acidic etching solution, metal plating the metal substrate, and removing the masking material.

The FIGURE illustrates a process for etching a metal substrate in accordance with the disclosure. As illustrated in the FIGURE, the masking material (e.g., a masking wax or other formulation) may first be applied by dipping the metal substrate into the hot masking material. After the metal substrate is cooled, the metal substrate is subjected to de-smutting in a caustic solution (e.g., NaOH or NaCN) followed by a rinsing step in water. After the rinsing step, the metal substrate is immersed in an etching solution (e.g., HCl or a mixture of HF and H₂SO₄). The metal substrate may then be rinsed again to remove the etching solution. The metal substrate is then plated (e.g., with chrome, cadmium, silver, or nickel) at an elevated temperature (e.g., between 140-160° F. for between 1-23 hours). The final step is then removal of the plating mask. Solvents and methods for removing the plating mask are described in more detail below.

According to an embodiment of the present disclosure, a formulation may be used to remove plating mask. The formulation may comprise a solvent blend or mixture. For example, a solvent blend for removing a plating mask may comprise a co-solvent and a vapor phase cleaning solvent. In certain aspects, the co-solvent may have a higher boiling point than the vapor phase cleaning solvent. Thus, at certain temperatures below the boiling point of the co-solvent, the solvent blend may produce a vapor that comprises only the vapor phase cleaning solvent with substantially no co-solvent. For example, as illustrated in the FIGURE, upon heating of a solvent blend in accordance with the disclosure within a vessel, three zones may result: a boil sump (i.e., reservoir), a vapor zone, and a cooling zone. Thus, upon heating, the boil sump may comprise a mixture of the co-solvent and the vapor phase cleaning solvent and the vapor zone may comprise the vapor phase cleaning solvent with substantially no co-solvent. The cooling zone is an area of the vessel that contains substantially none of the solvent blend (i.e., substantially no co-solvent and substantially no vapor phase cleaning solvent).

Various types of co-solvents may be included in solvent blends in accordance with the disclosure. The type and amount of the co-solvent may be adjusted to optimize for certain properties (e.g., solubility of the co-solvent with the masking material, compatibility of the co-solvent's boiling point with the mask removal process, or compatibility of the co-solvent with the metal substrate). In some embodiments, a plating mask may comprise a microcrystalline wax material.

In certain embodiments, the co-solvent is a solvent that has a high boiling point (e.g., a boiling point that is greater than 100 degrees Celsius). In some embodiments, the co-solvent may be a C₁₂-C₂₀ linear aliphatic saturated organic acid. In some embodiments, the co-solvent may be an organic ester, such as an oleic, stearic, or palmitic ester. In some embodiments, the co-solvent may be isopropyl myristate.

As described above, solvent blends in accordance with the disclosure may further comprise a vapor phase cleaning solvent. Various types of vapor phase cleaning solvents may be included in solvent blends in accordance with the disclosure. As described above with respect to the co-solvent, the type and amount of the vapor phase cleaning solvent may also be adjusted to optimize for certain properties (e.g., solubility of the vapor phase cleaning solvent with the masking material, compatibility of the vapor phase cleaning solvent's boiling point with the mask removal process, or compatibility of the vapor phase cleaning solvent with the metal substrate). In some embodiments, the vapor phase cleaning solvent may comprise a mixture of two or more solvents. In some examples, the two or more solvents may be an azeotropic mixture (i.e., a solvent mixture that has a constant boiling point and produces a vapor that has the same composition as the liquid). In some embodiments, the vapor phase cleaning solvent may comprise a mixture of trans-1,2-dichloroethylene and hydrofluoroether. In some embodiments, the vapor phase cleaning solvent may comprise trans-1,2-dichloroethylene with hydrofluoroolefins (HFO) or hydrofluorocarbons (HFC). In some embodiments, vapor phase cleaning solvents in accordance with the disclosure may comprise trans-1,2-dichloroethylene and hydrofluoroether that are combined at a ratio of 10:1 to 1:1.

The relative ratios of the co-solvent to the vapor phase cleaning solvent may also be varied. Thus, in some embodiments, solvent blends for removing a plating mask in accordance with the disclosure may comprise a co-solvent and a vapor phase cleaning solvent that are combined at a ratio of 4:1 to 1:1.

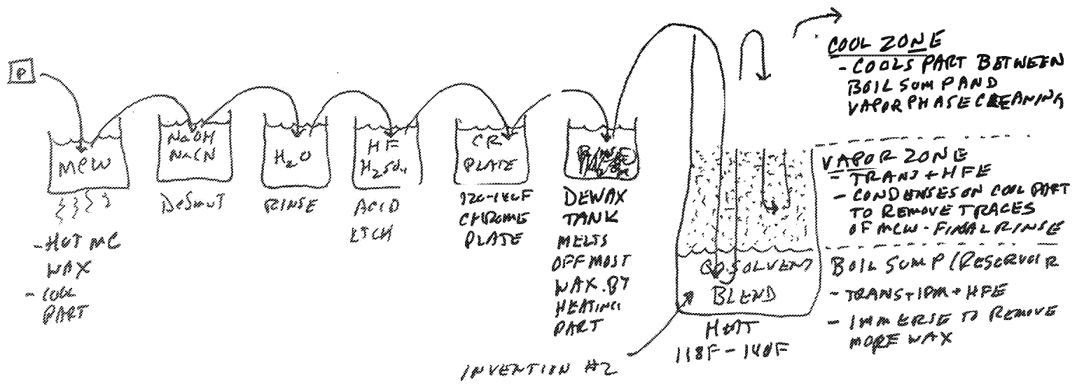

The disclosure further provides methods for removing a plating mask using solvent blends in accordance with the disclosure as described above. In embodiments, methods for removing a plating mask may comprise a first step that comprises a first cleaning period. In some embodiments, the first step comprises heating the solvent blend to an elevated temperature to produce a heated solvent blend. As described above, the solvent blend may comprise a co-solvent and a vapor phase cleaning solvent. As illustrated in FIG. 1, heating the solvent blend within a vessel can produce three zones within the vessel: a boil sump (i.e., a reservoir), a vapor zone, and a cooling zone. Following the heating step, a metal substrate that has a plating mask applied to it may be dipped or immersed into the solvent blend (i.e., into the boil sump) and maintained in the heated solvent blend for a period of time corresponding to a first cleaning period (e.g., 10 to 90 minutes).

In further embodiments, the metal substrate itself is heated prior to being dipped or immersed in the solvent blend (e.g., in a de-waxing tank as described below), and the heat from the metal substrate in turn heats the solvent blend. In embodiments, the metal substrate is heated to a sufficiently elevated temperature such that, upon being dipped or immersed in the solvent blend, the heat from the metal substrate causes the solvent blend to rigorously boil, assisting in removal of the plating mask. For example, in some embodiments, the plating mask comprises microcrystalline wax and the metal substrate is placed in a de-waxing tank prior to being dipped or immersed in the heated solvent blend as illustrated in the FIGURE. The mask detachment tank may comprise boiling water that melts some or all of the plating mask material. In other embodiments, the mask detachment tank may comprise a molten wax bath (e.g., 210-230° F.) for a period of time sufficient for the metal substrate to reach the same temperature as the molten wax bath and melt a portion of the plating mask wax off. In either case, the metal substrate is at an elevated temperature upon removal from the de-waxing bath. The de-waxing bath may be unable to completely remove all of the masking wax. Thus, a first cleaning period as described above in the solvent blend is necessary for complete removal of the masking wax.

Following the first cleaning period, the metal substrate may then be removed from the heated solvent blend and placed into the cooling zone for a period of time corresponding to a first cooling period, where the first cooling period is sufficient to lower the surface temperature of the part below the condensation point of the vapor. The first cooling period may vary depending on the mass of the part. As illustrated in the FIGURE, the cooling zone may be located within the vessel at a position above any vapor formed from the heated solvent blend (i.e., above the vapor zone illustrated in FIG. 1). In other embodiments, the cooling zone may be located outside of the vessel.

Following the cooling period, the metal substrate may then be placed in a position close enough to the heated solvent such that the metal substrate is in contact with the vapor produced from the vapor phase cleaning solvent (i.e., the vapor zone illustrated in the FIGURE) for a second cleaning period, where the second cleaning period is sufficient for the part to reach the condensation temperature of the vapor (e.g., 10 to 90 minutes). Because this step follows the first cooling period, the temperature of the metal substrate is below the boiling point of the vapor phase cleaning solvent. Thus, placement of the cooled metal substrate in the vapor zone causes vapor from the vapor phase cleaning solvent to condense onto the metal substrate and remove any remaining plating mask material (e.g., microcrystalline wax or microcrystalline wax and co-solvent solution). The final step of a method for removing a plating mask may then comprise moving the metal substrate back to the cooling zone for a second cooling period, where the second cooling period is sufficient to lower the surface temperature of the part below the condensation point of the vapor. The second cooling period may vary depending on the mass of the part.

While the present method or system has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, blocks or components of disclosed examples may be combined, divided, re-arranged, or otherwise modified. Therefore, the present method or system are not limited to the particular implementations disclosed. Instead, the present method or system will include all implementations falling within the scope of the appended claims, both literally and under the doctrine of equivalents.

What is claimed:

1. A solvent blend for removing a plating mask comprising a co-solvent and a vapor phase cleaning solvent, wherein the co-solvent has a higher boiling point than the vapor phase cleaning solvent.

2. The solvent blend of claim 1, wherein the co-solvent comprises isopropyl myristate.

3. The solvent blend of claim 1, wherein the vapor phase cleaning solvent comprises a mixture of trans-1,2-dichloroethylene and hydrofluoroether.

4. The solvent blend of claim 3, wherein the vapor phase cleaning solvent comprises trans-1,2-dichloroethylene and hydrofluoroether are combined at a ratio of between 10:1 and 1:1.

5. The solvent blend of claim 4, wherein the vapor phase cleaning solvent comprises trans-1,2-dichloroethylene and hydrofluoroether are combined at a ratio of between 10:1 and 8:1.

6. The solvent blend of claim 1, wherein the co-solvent and the vapor phase cleaning solvent are combined at a ratio of between 4:1 and 1:1.

7. The solvent blend of claim 6, wherein the co-solvent and the vapor phase cleaning solvent are combined at a ratio of between 4:1 and 3:1.

8. A method for removing a plating mask comprising:
heating a solvent blend that comprises a co-solvent and a vapor phase cleaning solvent to an elevated temperature to produce a heated solvent blend, wherein the co-solvent has a higher boiling point than the vapor phase cleaning solvent;
dipping a metal substrate that has had a plating mask applied to it into the heated solvent blend;
maintaining the metal substrate in the heated solvent blend for a first cleaning period;
removing the metal substrate from the heated solvent blend and into a cooling zone for a cooling period, wherein the cooling zone is located at a position above any vapor formed from the heated solvent blend;
placing the metal substrate in a position close enough to the heated solvent such that the metal substrate is in contact with the vapor produced from the vapor phase cleaning solvent for a second cleaning period; and
moving the metal substrate to the cooling zone for a second cooling period.

9. The method of claim 8, wherein the co-solvent comprises isopropyl myristate.

10. The method of claim 8, wherein the vapor phase cleaning solvent comprises a mixture of trans-1,2-dichloroethylene and hydrofluoroether.

11. The method of claim 10, wherein the vapor phase cleaning solvent comprises trans-1,2-dichloroethylene and hydrofluoroether at a mixed at a ratio of between 10:1 and 1:1.

12. The method of claim 11, wherein the vapor phase cleaning solvent comprises trans-1,2-dichloroethylene and hydrofluoroether are combined at a ratio of between 10:1 and 8:1.

13. The method of claim 8, wherein the co-solvent and the vapor phase cleaning solvent are combined at a ratio of between 4:1 and 1:1.

14. The method of claim 13, wherein the co-solvent and the vapor phase cleaning solvent are combined at a ratio of between 4:1 and 3:1.

15. The method of claim 8, wherein the elevated temperature is lower than the melting point of the plating mask.

16. The method of claim 8, wherein the plating mask comprises microcrystalline wax.

17. The method of claim 16, wherein the metal substrate is subjected to a de-waxing tank prior to dipping the metal substrate into the heated solvent blend.

18. The method of claim 17, wherein the de-waxing tank comprises boiling water.

19. The method of claim 17, wherein the de-waxing tank comprises molten wax.
